(19) United States
(12) Patent Application Publication
(10) Pub. No.: US 2007/0087693 A1
(43) Pub. Date: Apr. 19, 2007

(54) Common announcement signaling format

(76) Inventor: David Johnston, Beaverton, OR (US)

Correspondence Address: INTEL CORPORATION;C/O INTELLEVATE, LLC, P.O. BOX 52050, MINNEAPOLIS, MN, 55402, US

(21) Appl. No.: 11/253,025

(22) Filed: Oct. 17, 2005

(51) Int. Cl. H04B 1/00

(52) U.S. Cl. 455/63.1; 455/3.01

(57) ABSTRACT

A licensed wireless device may generate a Direct Sequence (DS) coded signal to provide an announcement signal with an expanded footprint that declares ownership of a licensed band to unlicensed wireless devices. The coded announcement signal may be overlaid on an active signal, transmitted on a channel that is separate from the data channel or broadcast on an unlicensed band.

A wireless communication device in a wireless network may be within communication range of another device or a collection of devices. The communication device may have a license to use a piece of radio spectrum in some or any location, while the other devices may be unlicensed users that are required by law to avoid interfering with the radio signals of the licensed device. The communication device may be capable of operating in one of many frequency bands and may operate with a transmission format that is different from the other devices. In this environment, a licensed communication device may not be able to communicate with the unlicensed devices and data packets cannot be exchanged, however the radio signals from the unlicensed devices may interfere with those from the licensed communication device. Essentially, the licensed and unlicensed devices may not hear each other and a solution is needed to resolve the problem to avoid interference.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that incorporates circuitry and an algorithm to overlay a single signaling format on many different transmission formats and frequencies to enable detection of other users in accordance with the present invention;

FIG. 2 is a diagram that illustrates unlicensed users “A” and “B” and a licensed user “C” that periodically transmits an announcement signal having a detectable footprint; and

FIG. 3 is a diagram that illustrates one embodiment of the single signaling format, a Direct Sequence (DS) encoded signal, used by the wireless device of FIG. 1.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements may or may not be in direct contact with each other, but yet still co-operate or interact with each other.

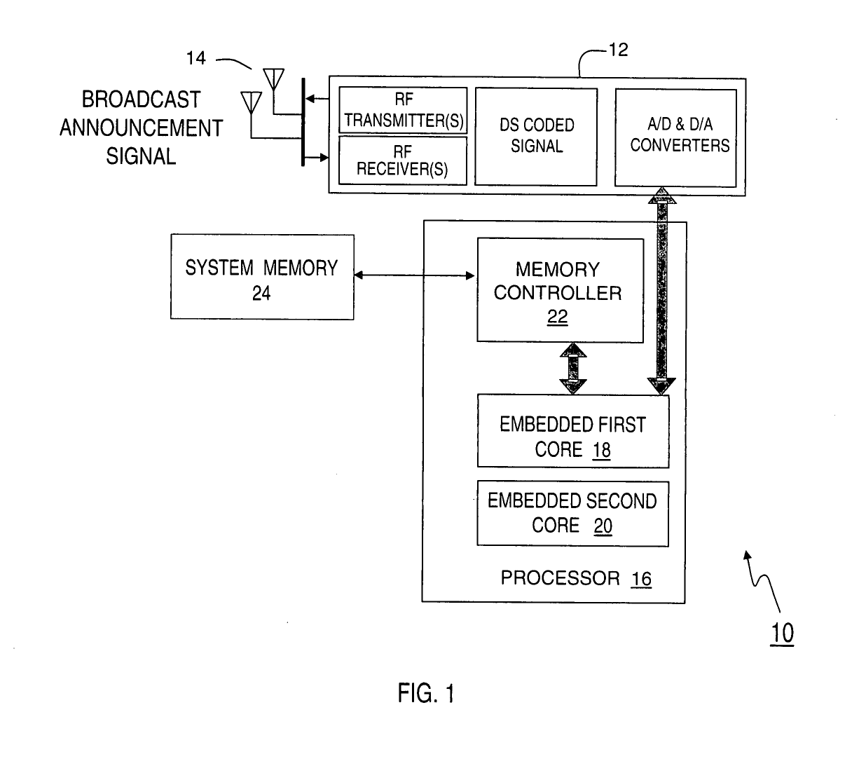

FIG. 1 illustrates features of the present invention that may be incorporated, for example, into a wireless communications device 10. In the wireless communications embodiment, a transceiver 12 both receives and transmits a modulated signal from one or multiple antennas 14. A received modulated signal may be frequency down-converted and converted to a baseband, digital signal for processing by a processor 16. Processor 16 may include baseband and applications processing functions and utilize one or more processor cores 18 and 20. The use of multiple cores may allow one core to be dedicated to handle application specific functions, or alternatively, the multiple cores may allow processing workloads to be shared across the cores.

Processor 16 may include a memory controller 22 to facilitate data exchanges across a hardware/software interface with system memory 24. System memory 24 may include a combination of memories such as a Random Access Memory (RAM), a Read Only Memory (ROM) and a nonvolatile memory, although the type or variety of memories included in system memory 24 is not a limitation of the present invention.

The radio in communications device 10 allows communication in an RF/location space with other devices and may include network connections to send and receive files or other information such as voice or video and high definition streaming video. As such, wireless communications device 10 may have applications in a variety of electronic devices such as laptops, mobile phones, cameras, Personal Digital Assistants (PDAs) and communicators, medical or biotech equipment, automotive safety and protective equipment and infotainment products. However, it should be understood that the scope of the present invention is not limited to these examples.

In accordance with the present invention, the radio in communications device 10 may be used to establish communication with other wireless devices that may operate in a variety of different networks. As such, different radio technologies may be built into the platform of communications device 10 that allow collocation and operability in selected networks that may employ cellular, Wireless Local Area Networks (WLANs), Wireless Personal Area Networking (WPAN), Worldwide Interoperability for Microwave Access (WiMax), Wireless Fidelity (Wi-Fi™), and Bluetooth™, among others. These networks may use different modulation techniques such as Code Division Multiple Access (CDMA), WCDMA, Global System for Mobile Communications (GSM), Time-Division Multiplexing (TDM), Vestigial Side Band (VSB), Amplitude Modulation (AM), Phase Shift Keying (PSK) and Orthogonal Frequency Division Multiplexing (OFDM) to enable data communications and data exchanges at different frequencies for a variety of applications. Neither the type of network nor the type of modulation selected by communications device 10 is intended to limit the claimed invention.

In some embodiments the radio in communications device 10 may include Ultra High Frequency/Very High Frequency (UHF/VHF) technologies built into the platform.

The UHF/VHF transceiver may be coupled to antenna 14 to communicate over a channel that is in a UHF/VHF frequency range, i.e., a frequency range of 50-806 MHz corresponding to channels 2-69. Note that in order to accommodate the various frequency bands, transceiver 12 may employ multiple radios, however, the number of radios in transceiver 12 is not limiting the scope of the present invention.

Communications device 10 periodically generates an announcement signal having a particular signaling format that is applicable to a variety of different transmission formats and frequencies. In one embodiment the particular signaling format may be an overlay on the actual data signal to provide an announcement transmission that is acceptable to multiple networks and useable across multiple radio technologies. In another embodiment the announcement signal may be transmitted on a channel that is separate from the data channel, i.e., the announcement signal may be transmitted on an adjacent unused channel. By not collocating the announcement signal on the same channel that the signal to be protected occupies, the requirements on detection hardware may be relaxed and the announcement signal can be placed in a channel with a better propagation characteristic. In yet another embodiment the announcement signal may be broadcast on an unlicensed band. Thus, in accordance with the present invention communications device 10 is capable of periodically transmitting an announcement signal that declares ownership of a licensed band and permits coexistence between diverse media networks.

In general, communications device 10 is any type of wireless device capable of transmitting/receiving the particular signaling format provided in the announcement signal. The particular signaling format transcends a signature signal such as, for example, a hashed signature that announces the presence of the device operating in a particular band. Instead, the announcement signal of the present invention may include a declaration of spectrum that is licensed, along with information on transmitter location, channels occupied and an interference footprint or profile, although this information is for illustrative purposes only and other information may be provided.

Thus, communications device 10 periodically provides the announcement signal with a “universal” format that includes coded properties that declare ownership of a licensed band and location information to any unlicensed users. Upon receiving the announcement signal from communications device 10, an unlicensed device may compare location and interference contour data against its own location and transmitter characteristics to determine if it will interfere. The unlicensed users may then take steps to avoid interference that may include switching frequency bands and/or reducing transmission power.

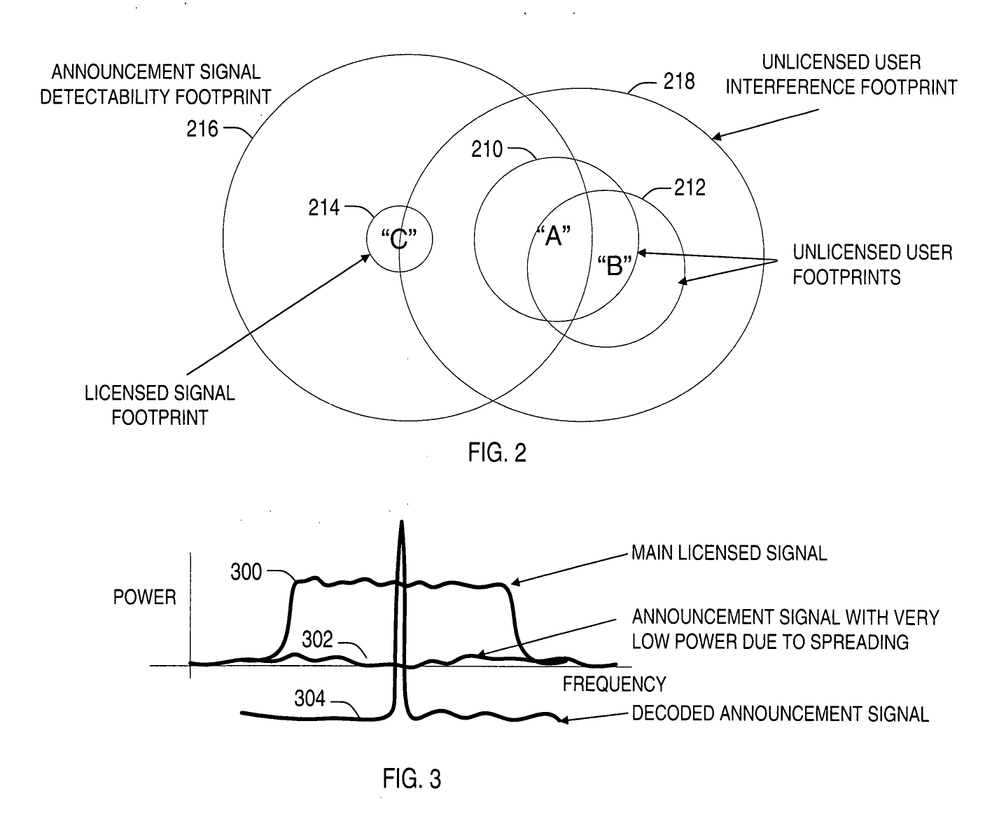

FIG. 2 further illustrates that unlicensed users “A” and “B” would be unaware of licensed user “C” within the licensed signal footprint 214 and could interfere. Unlicensed users “A” and “B” have respective signal footprints 210 and 212 and licensed user “C” has a licensed signal footprint 214. Note that the unlicensed users present a collective interference footprint 218 consisting of both intentional and spurious emissions that is larger than the useable communication footprint. In order to mitigate channel interference and detect hidden devices, one feature of the present invention is that licensed user “C” periodically transmits an announcement signal having a footprint 216 that is receivable over a significantly greater area than the licensed signal footprint 214.

The unlicensed users “A” and “B” receive the announcement signal, compare location and interference contour data against its own location and transmitter characteristics and then take steps to avoid interfering with user “C”. The interaction of unlicensed users “A” and “B” and licensed user “C” improves service quality by employing a system with a signaling format that endows an announcement signal with a greater footprint to announce it's presence to any hidden users. This allows licensed and unlicensed users to be collocated, share spectrum, reduce unwanted interference and provide the desired transmission qualities.

FIG. 3 is a diagram that illustrates one embodiment of the single signaling format, e.g., a Direct Sequence (DS) coded signal, that may be generated by wireless communications device 10 of FIG. 1. Referring to FIGS. 2 and 3, licensed user “C” has a licensed signal footprint 214 that in FIG. 3 is labeled as the main licensed signal 300. Licensed user “C” periodically generates the announcement signal with the greater footprint labeled 216 in FIG. 2 and the main licensed signal labeled 300 in FIG. 3. By spreading the signal 300 with a high spreading factor and transmitting a very low data rate, the per bit signal energy can be spread both in frequency and time and distinguished by DS code, allowing this announcement signal 302 to be overlaid non destructively with many different data signal formats that operate with a much higher bps/hz. The announcement signal may be decoded by either of the unlicensed users “A” and “B” (decoded signal is labeled 304 in FIG. 3).

By now it should be apparent that the present invention in a wireless device may alleviate the interference problem by periodically providing an announcement signal with a sufficiently large footprint to enable unlicensed users to be aware of the signal from any transmitter within their interference footprint and take action so that they do not interfere in that band and location. The announcement signal may use conventional DS spreading with a low data rate for the specific purposes of creating a low intrusion announcement channel that may or may not be co-located on the main signal channel. The announcement signal coding can use the same front end radio technology and possibly the same signaling method across multiple radio technologies.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
operating a wireless device by an unlicensed user;
transmitting a periodic announcement signal to declare ownership of a licensed band and provide location information by a licensed user, the announcement signal having a footprint that is larger than an interference footprint of the unlicensed user.

2. The method of claim 1 wherein transmitting the periodic announcement signal further includes transmitting a Direct Sequence (DS) coded signal.

3. The method of claim 1 wherein transmitting the periodic announcement signal further includes declaring ownership of the licensed band to the unlicensed wireless device.

4. The method of claim 1 wherein transmitting the periodic announcement signal further includes overlaying the periodic announcement signal on an active signal.

5. The method of claim 1 wherein transmitting the periodic announcement signal further includes transmitting on a channel that is separate from the data channel.

6. The method of claim 1 wherein transmitting the periodic announcement signal further includes transmitting on an unlicensed band.

7. A method comprising:
transmitting a periodic announcement signal by a licensed user to declare ownership of a licensed band, wherein the announcement signal is a Direct Sequence (DS) coded signal that includes location information.

8. The method of claim 7 wherein transmitting the periodic announcement signal further includes spreading the announcement signal with a high spreading factor and transmitting at a very low data rate to spread the signal both in frequency and time.

9. The method of claim 7 wherein transmitting the periodic announcement signal further includes encoding and overlaying the periodic announcement signal on an active signal.

10. The method of claim 7 wherein transmitting the periodic announcement signal further includes transmitting on an unlicensed band.

11. The method of claim 7 wherein transmitting the periodic announcement signal further includes transmitting on an adjacent unused channel.

12. The method of claim 7 wherein the announcement signal has an expanded footprint that declares ownership of a licensed band to unlicensed wireless devices.

13. A method comprising:
periodically transmitting an announcement signal by a licensed wireless device by spreading the announcement signal with a spreading factor and transmitting at a data rate to provide a footprint radiating from the wireless device that is larger than a footprint when the announcement signal is not transmitted.

14. The method of claim 13 wherein transmitting the periodic announcement signal by the licensed user declares ownership of a licensed band.

15. The method of claim 13 wherein transmitting the periodic announcement signal by the licensed user includes transmitting a Direct Sequence (DS) coded signal that includes location information.

16. A wireless device comprising:
a processor;
a transceiver coupled to the processor to periodically provide an announcement signal using a spreading factor; and
an antenna to transmit the announcement signal with a radiating first footprint that is larger than a footprint when the announcement signal is not transmitted.

17. The wireless device of claim 16 wherein the processor is a dual core processor.

18. The wireless device of claim 16 wherein the announcement signal is a Direct Sequence (DS) coded signal that includes location information.

19. The wireless device of claim 16 wherein the announcement signal is a Direct Sequence (DS) coded signal that declares ownership of a licensed band.

20. The wireless device of claim 16 wherein the announcement signal is transmitted on an adjacent unused channel.
